(19) United States
(12) Patent Application Publication
(10) Pub. No.: US 2026/0059602 A1
(43) Pub. Date: Feb. 26, 2026

(54) METHOD AND APPARATUS FOR ROBUST SMALL DATA TRANSMISSION IN A WIRELESS NETWORK

(71) Applicant: Continental Automotive Technologies GmbH, Hannover (DE)

(72) Inventors: Rikin Shah, Langen (DE); David Gonzalez Gonzalez, Egelsbach (DE); Osvaldo Gonsa, Frankfurt (DE); Hojin Kim, Regensburg (DE)

(73) Assignee: Continental Automotive Technologies GmbH, Hannover (DE)

(21) Appl. No.: 19/099,454

(22) PCT Filed: Jul. 27, 2023
(86) PCT No.: PCT/EP2023/070842

§ 371 Date: Jan. 28, 2025

(30) Foreign Application Priority Data
Jul. 29, 2022 (DE) 10 2022 207 895.0

(51) Int. Cl. H04W 76/20; H04B 17/318; H04W 56/00; H04W 68/02; H04W 74/0836

(52) U.S. Cl. CPC H04W 76/20; H04B 17/328; H04W 56/0015; H04W 68/02; H04W 74/0836

(57) ABSTRACT

Mobile-terminated Small Data Transmission is received in a wireless communication network by: receiving a paging notification from a base station while in inactive state, the paging notification comprising at least an indication that downlink small data is available for transmission, and a priority flag associated with said downlink small data; determining at least one Synchronization Signal Reference Signal Received Power; and postponing downlink data reception until the next paging cycle when the priority flag indicates low priority downlink data, and all of the Synchronization Signal Reference Signal Received Powers are below a threshold. A base station performs small data transmission.

### CROSS-REFERENCE TO RELATED APPLICATIONS

The present application is a National Stage Application under 35 U.S. C. § 371 of International Patent Application No. PCT/EP2023/0708421 filed on Jul. 27, 2023, and claims priority from German Patent Application No. 10 2022 207 895.0 filed on Jul. 29, 2022, in the German Patent and Trademark Office, the disclosures of which are herein incorporated by reference in their entireties.

### TECHNICAL FIELD

The application generally relates to wireless communications and, more particularly, to apparatuses and methods for improving Mobile Terminated-Small Data Transmission (MT-SDT) in a Radio Resource Control (RRC) inactive state.

### BACKGROUND

Because transitioning from a RRC Inactive or RRC idle state to a RRC connected state might cause overheads for a User Equipment (UE) when only a small amount of data is to be transmitted, 3rd Generation Partnership Project (3GPP) has introduced technologies to optimize such small packets transmission. Indeed, UE needs to exchange multiple control signals to initiate and maintain a connection with a network. When payload size is relatively small compared with the amount of required control signals, establishing a connection becomes a concern for both the network and UE due to control signaling overhead.

Small Data Transmission (SDT) in RRC Inactive state has been introduced in 3GPP Release 17 for 5G NR to reduce signaling overhead and UE power consumption for infrequent data transmission. It allows UEs to transmit sporadic and small amount of data in RRC Inactive state, without requiring an RRC state transition.

The RRC Inactive state was introduced to keep the AS (Access Stratum) context at the base station and UE, with the aim of reducing energy consumption and the number of messages exchanged between a user equipment and a base station. In the RRC Inactive state, the user equipment and the base station suspend their radio connection, but the AS context is preserved in the user equipment and the base station.

Two types of SDT have been defined by 3GPP depending on how radio resources are configured: SDT using a random access (RA-SDT) and SDT using preConfigured Grant (CG-SDT). RACH (Random Access CHannel) based SDT allows SDT using an uplink grant received via a random access procedure for SDT. CG based SDT allows SDT from an RRC inactive state using a configured grant without performing a random access procedure.

Small Data Transmission using the preconfigured radio resource is referred to as transmission via PUR (Preconfigured Uplink Resource) in the LTE standards and CG-SDT (Configured Grant based SDT) in 5G NR standard. The base station configures radio resources when transiting the user equipment from RRC connected to RRC inactive state, for example in a RRC Release message including radio resource configuration for PUR of CG-SDT.

Small Data Transmission using the random access is referred to as an EDT (early data transmission) in LTE standard and RA-SDT (Random Access based SDT) in 5G NR (New Radio) standard. Data is transmitted using shared radio resources of the random access procedure.

Basically, when a base station needs to send a small amount of data to a user equipment in RRC Inactive state, it sends a paging notification to the user equipment. Such paging message is sent in SSB (Signal Synchronization Block) using QPSK (Quaternary Phase Shift Keying) modulation for Physical Downlink Control Channel (PDCCH), making it possible for the user equipment to decode the message even in low RSRP (Reference Signal Received Power) conditions. However, actual downlink data transmission may not be carried over a QPSK modulation and could be subject to errors in low RSRP conditions, leading to packets retransmissions and overheads.

Moreover, UE may receive paging notification indicating SDT in RRC_INACTIVE when no SSB's RSRP is above a preconfigured threshold. In such a situation, downlink SDT retransmission could occur which would result more power consumption and signaling overhead.

Therefore, there is a need for an efficient way of transmitting Small Data in RRC inactive state.

### BRIEF SUMMARY

In one aspect, a method for receiving Small Data Transmission by a user equipment device connected to a wireless communication network is proposed. The method comprises the following steps:
Receiving a paging notification from a base station while in inactive state, the paging notification comprising at least: an indication that downlink small data is available for transmission, and a priority flag associated with said downlink small data,
determining at least one Synchronization Signal Reference Signal Received Power, and
postponing downlink data reception until next paging cycle when said priority flag indicates low priority downlink data and said at least one Synchronization Signal Reference Signal Received Power is below a threshold.

It is thus contemplated that a paging notification sent by a base station serving a user equipment for notifying that downlink Small Data is available comprises an indication regarding the priority of said downlink data. The priority indication may be a binary flag indicating whether or not available small data is of high priority. In case none of the SSB's RSRP (Synchronization Signal Reference Signal Received Power, SS-RSRP) is above a preconfigured threshold (i.e., when a user equipment is experiencing poor radio conditions), the user equipment may decide to postpone the receiving of said small data to a next paging cycle.

This avoids transmitting non-urgent small data when poor network conditions are experienced, thus avoiding packet retransmissions and signaling overhead, while reducing power consumption.

In this application, the terms “send” and “transmit” are equivalent and can be inter-changed.

According to an embodiment, when said priority flag indicates high priority downlink data and said at least a Synchronization Signal Reference Signal Received Power is below a threshold, the method further comprises the following steps:
sending a paging response comprising at least a flag indicating that said at least one Synchronization Signal Reference Signal Received Power is below a threshold, and receiving downlink data from the base station, said downlink data being transmitted using a low modulation scheme selected by said base station when based on said indication that all of the at least one Synchronization Signal Reference Signal Received Powers are below a threshold.

It is thus proposed that a user equipment sends a flag indicating that all SSB's RSRP are below a threshold in response to the paging notification. Such a provision allows a serving base station to adapt its behavior to the signal quality experienced by the user equipment, for example by transmitting pending small data using a low MCS (Modulation and Coding scheme).

In some examples, user equipment transmits this indication to the base station through a 2-step RACH (Random Access Channel), a 4-step RACH or a CG (preConfigured Grant).

According to an embodiment, when said priority flag indicates high priority downlink data and said at least a Synchronization Signal Reference Signal Received Power is below a threshold, the method further comprises the steps: Sending a paging response comprising at least a quality flag indicating that all of said at least one Synchronization Signal Reference Signal Received Powers are below a threshold, and receiving an instruction for skipping downlink data.

It is thus proposed that a user equipment sends a flag indicating that all SSB's RSRP are below a threshold in response to the paging notification. Such a provision allows a serving base station to adapt its behavior depending on a signal quality experienced by the user equipment, for example by skipping small data transmission and scheduling it in a next paging cycle. In this case, the small data transmission may be re-scheduled and transmitted in one of the next paging cycles. That is, the transmission may be re-scheduled.

According to an embodiment, the steps of sending a paging response comprising at least a flag indicating that said all of the at least one Synchronization Signal Reference Signal Received Powers are below a threshold, and receiving an instruction for skipping downlink data until next paging cycle are performed repeatedly; and if a stop-criterion occurs, the step receiving downlink data from the base station, said downlink data being transmitted using a low modulation scheme selected by the said base station, is performed.

In other words, a combination of the two measures, i.e. receiving the small data transmitted at a low modulation scheme and skipping or re-scheduling may be possible. That is for example, if the re-scheduling is not successful because the radio conditions did not improve, a low modulation scheme may be selected by the base station for the transmission, which then can be received by the user equipment. A stop criterion may be defined for stopping the re-scheduling and switching to the selected low modulation scheme.

According to an embodiment, the stop-criterion is one of a pre-configured number of repetitions, a further flag in the paging message, a further flag in the paging response message, or a detected static or deteriorating radio condition.

According to an embodiment, the pre-configured number of repetitions is configured in the base station and/or the user equipment device.

The present disclosure also contemplates an apparatus for receiving Small Data Transmission (SDT) from a base station in a wireless communication network, the apparatus comprising a processor coupled with a memory in which computer program instructions are stored, said instructions being configured to implement the following steps:
Receiving a paging notification from a base station while in inactive state, the paging notification comprising at least: an indication that downlink data is available for transmission, and a priority flag associated with said downlink data, determining at least a Synchronization Signal Reference Signal Received Power,
and
postponing downlink data reception until at least the next paging cycle when said priority flag indicates low priority downlink data and said at least one Synchronization Signal Reference Signal Received Power is below a threshold.

According to an embodiment, the apparatus further comprises a scheduler unit configured to postpone downlink data reception until at least the next paging cycle when said priority flag received by communication unit indicates low priority downlink data and when the channel quality sensor determines that said measured all SSB's RSRP are below said threshold.

The scheduler unit may be configured to determine the data cycle for transmitting the small data that has not been sent according to one of different algorithms. Such algorithms may be selecting the next paging cycle, selecting a fixed number or varying number such as a random number or an increasing or decreasing of paging cycles to be skipped, or the algorithm may even take into account measured radio conditions. Further criteria or any mix of these criteria may be applied.

It is further contemplated a user equipment comprising an apparatus for receiving Small Data Transmission as described above.

The present disclosure also relates to a method for sending Small Data Transmission by a base station in a wireless communication network, wherein the method comprises:
Transmitting a paging notification to a user equipment in inactive state, the paging notification comprising at least: an indication that downlink small data is available for transmission, and a priority flag associated with said downlink small data,
receiving a paging response comprising at least an indication that all of at least one Synchronization Signal Reference Signal Received Powers are below a threshold, and
transmitting downlink data using a modulation scheme selected based on said Synchronization Signal Reference Signal Received Power indication received.

According to an embodiment, in case that the priority flag indicates high priority downlink data, the step transmitting downlink data using a modulation scheme selected based on said Synchronization Signal Reference Signal Received Power indication received is preceded by the steps receiving a paging response comprising at least a flag indicating that all of the at least one Synchronization Signal Reference Signal Received Powers are below a threshold, and transmitting an instruction for skipping downlink data until next paging cycle.

In embodiments, a base station serving a user equipment may thus send an indication regarding a priority associated with available downlink small data in a paging notification. The priority indication may be a binary flag indicating whether or not available small data is of high priority. Such an indicator makes it possible for a user equipment to adapt its behavior in case of a low quality radio signal. For example, a user equipment may skip downlink data transmission until the next or a further paging cycle. In some embodiment, the user equipment may send a response containing a signal quality indicator (e.g., an indication regarding the fact that all SSB's RSRP are below a threshold) that may be used by the base station to select a robust MCS to transmit pending small data. The measure of skipping the small data transmission may be performed repeatedly and may be optionally stopped when a stop criterion is fulfilled, followed by transmitting the small data using a low modulation scheme. The stop criterion may be, for example, one of a pre-configured number of repetitions, a further flag in the paging message, a further flag in the paging response message, or a detected static or deteriorating radio condition. Preferably, the skipping or rescheduling of the download is performed if low priority data is to be transmitted, and a low modulation scheme is used if high priority data is to be transmitted. Alternatively, the download is performed in the next cycle if high priority data is to be transmitted. The combination, i.e., when the base station tries to send the data in a following paging cycle, and then to transmit the data with a low modulation scheme, may be performed accordingly either with low priority data, where the transmission first is postponed or high priority data, where the transmission first is performed in the next paging cycle. It is also contemplated an apparatus for performing Small Data Transmission in a wireless communication network, the apparatus comprising a wireless transceiver and a processor coupled with a memory in which computer program instructions are stored, said instructions being configured to implement steps of:
Transmitting a paging notification to a user equipment in inactive state, the paging notification comprising at least: an indication that downlink small data is available for transmission, and a priority flag associated with said downlink small data,
receiving a paging response comprising at least an indication that at least a Synchronization Signal Reference Signal Received Power is below a threshold,
and
transmitting downlink data using a modulation scheme selected based on said Synchronization Signal Reference Signal Received Power indication received.

It is further contemplated a base station comprising an apparatus for performing small data transmission as described above.

The present disclosure further relates to a wireless communication system comprising a base station and a user equipment for performing small data transmission from the base station to the user equipment, wherein the base station comprises a processor coupled with a memory in which computer program instructions are stored, said instructions being configured to implement steps of:
Transmitting a paging notification to a user equipment in inactive state, the paging notification comprising at least: an indication that downlink small data is available for transmission, and a priority flag associated with said downlink small data, wherein the user equipment comprises a processor coupled with a memory in which computer program instructions are stored, said instructions being configured to implement steps of:
Receiving said paging notification from a base station while in inactive state, the paging notification comprising at least: an indication that downlink data is available for transmission, and a priority flag associated with said downlink data, determining at least one Synchronization Signal Reference Signal Received Power, and
postponing downlink data reception until at least next paging cycle when said priority flag indicates low priority downlink data and all of said at least one Synchronization Signal Reference Signal Received Power are below a threshold.

In some embodiments, the various steps of the method for receiving Small Data Transmission by a user equipment and/or the method for sending Small Data Transmission by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station disclosed herein.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may be downloaded from a network.

Alternatively, the information medium may be an integrated circuit into which the program is incorporated, the circuit being arranged to execute or to be used in the execution of the methods in question.

The advantages of apparatus, user equipment, base station, system, and corresponding computer programs and information mediums are identical to those presented in relation with the method for receiving Small Data and method of performing Small Data according to any one of the embodiments mentioned hereinabove.

### BRIEF DESCRIPTION OF THE DRAWINGS

Other advantages and characteristics of the invention will be more clearly apparent on reading the following description, given by way of simple illustrative and non-limiting example, and the appended drawings.

FIG. 1 illustrates a wireless system comprising a user equipment and a base station, in which aspects of the present disclosure may be practiced.

FIG. 2 is a diagram illustrating a UE-terminated low-priority small data transmission example in RRC Inactive state, according to an embodiment.

FIG. 3a is a diagram illustrating a UE-terminated high-priority small data transmission example in RRC Inactive state, according to an embodiment.

FIG. 3b is a diagram illustrating a UE-terminated high-priority small data transmission example in RRC Inactive state, according to an embodiment.

FIG. 4 is a flow chart depicting main steps of a state machine suitable for implementing a method for receiving small data transmission by a user equipment according to an embodiment.

FIG. 5 is a flow chart showing main steps of a state machine suitable for implementing a method for performing small data transmission by a base station according to an embodiment.

FIG. 6 is a flow chart depicting main steps of a state machine suitable for implementing a method for receiving small data transmission by a user equipment according to a further embodiment.

FIG. 7 is a flow chart showing main steps of a state machine suitable for implementing a method for performing small data transmission by a base station according to a further embodiment.

FIG. 8 is a block diagram showing a schematic architecture of an apparatus suitable to implement a method of wireless communication for receiving a Small Data Transmission (SDT) from a base station, according to an embodiment.

FIG. 9 is a block diagram showing a schematic architecture of an apparatus suitable to implement a method of wireless communication for performing a Small Data Transmission (SDT) to a user equipment, according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

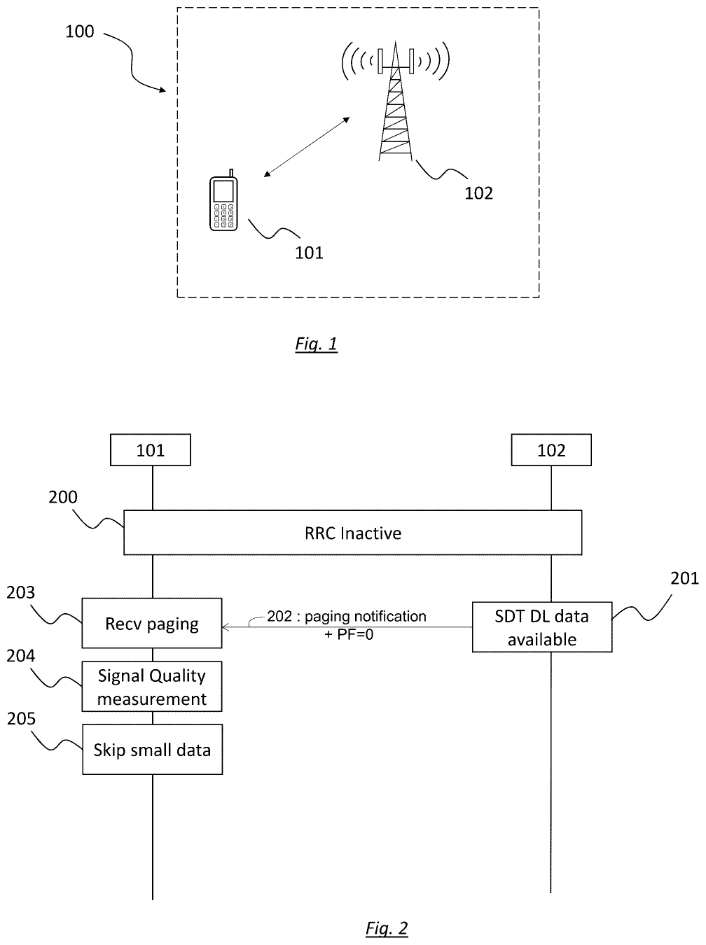

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as LTE, 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provides radio communication coverage for a particular geographic area called “cell”.

User equipment 101 may be referred to as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

User equipment 101 may support various communication modes, such as a connected mode (RRC Connected), an inactive mode (RRC Inactive), or an idle mode (RRC Idle) as defined by 3GPP. When operating in RRC Connected mode, user equipment 101 is active and communicates with base station 102. User equipment 101 may transition from communication mode to another using various commands and messages received from the base station 102. For example, user equipment 101 may switch from RRC Connected state to RRC Inactive state upon receiving a RRC Release message including suspendConfig parameter.

User equipment 101 may enter RRC Inactive state without completely releasing radio resources when there is no traffic, in order to switch quickly back to RRC Connected state when necessary. In this case, user equipment and base station may store a context for the user equipment, for example an access stratum (AS) context, in order to apply said stored context when transitioning from RRC Inactive to RRC Connected state and thus reduce latency and signaling overhead. Such context may include radio configuration parameters, such as uplink grant, RNTI (Radio Network Temporary Identifier), MCS and/or the like.

However, radio conditions may have changed while user equipment 101 is RRC Inactive state. For example, user equipment 101 may have moved to another location, thus altering channel quality.

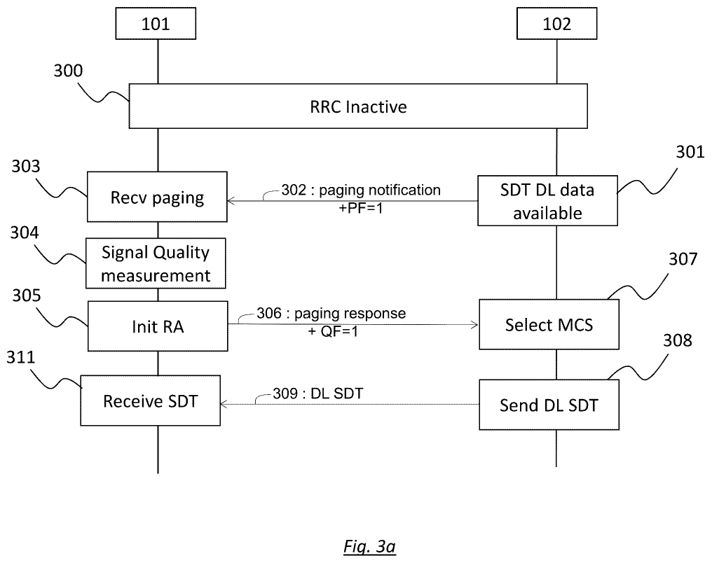

FIG. 2 is a diagram illustrating a UE-terminated low-priority small data transmission example in RRC Inactive state, according to an embodiment.

During a preliminary step 200, user equipment 101 may switch to RRC inactive state in response to a RRC Release message with suspendConfig parameter. An I-RNTI (Inactive Radio Network Temporary Identifier) may be allocated to user equipment 101 within such RRC Release message as part of suspendConfig parameter.

While user equipment 101 is in RRC Inactive state, the base station 102 may receive, at step 201, downlink small data destined for user equipment 101. The downlink data may include a small amount of data like keep-alive packets, sensor data, push notifications, location data, etc. Base station 102 may transmit a paging notification 202 to user equipment 101 to inform about available downlink data, the paging notification comprising at least an identifier associated to the user equipment 101, for example a I-RNTI.

In some embodiments, the paging notification comprises an indication that downlink small data is available for transmission, and a priority flag associated with said downlink small data. The priority flag may be a one-bit binary flag set by base station 102 when the received data is of high priority. A high priority flag may be set depending on several factors, like data priority, data volume threshold, traffic pattern or the like. In some examples, the paging notification message may include a one-bit PagingDLdataInformation field in the PagingUE-Identity data structure defined by 3GPP TS38.331 specification.

The user equipment 101 receives the paging notification 202 at step 203 and decodes the priority flag set by the base station 102.

At step 204, user equipment 101 may measure the signal quality and determine at least a Synchronization Signal Reference Signal Received Power.

According to an embodiment, if user equipment receives “0” in the paging message 202 (i.e., low priority data), and if all SSB's RSRP determined at step 204 are below a preconfigured threshold, it may skip Random Access (RA) procedure and go back to sleep mode at step 205 and wake up in the next paging cycle. The threshold may be a RSRP threshold defined by 3GPP. Therefore, the small data reception is skipped for this cycle and may be received in one of the following cycles if at least one SSB's RSRP is above the preconfigured threshold.

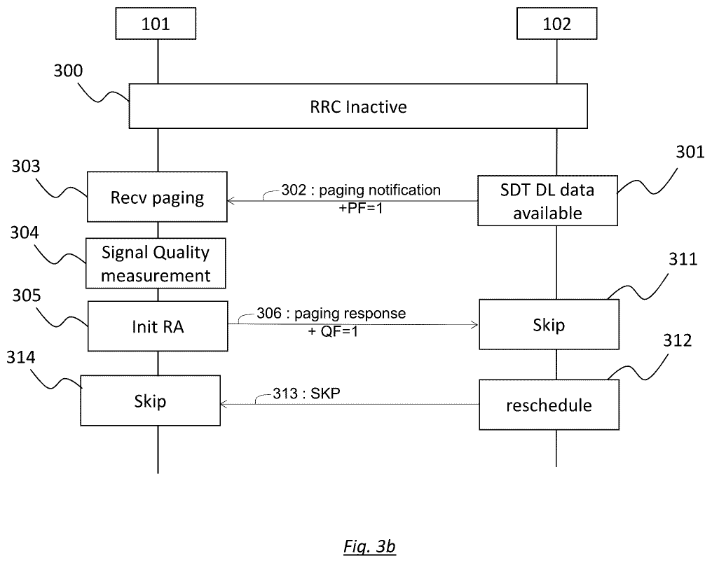

FIG. 3a is a diagram illustrating a UE-terminated high-priority small data transmission example in RRC Inactive state, according to an embodiment.

During a preliminary step 300, user equipment 101 may switch to RRC inactive state in response to a RRC Release message with suspendConfig parameter. An I-RNTI (Inactive Radio Network Temporary Identifier), may be allocated to user equipment 101 within such RRC Release message as part of suspendConfig parameter.

While user equipment 101 is in RRC Inactive state, the base station 102 may receive, at step 301, downlink small data destined for user equipment 101. The downlink data may include a small amount of data like keep-alive packets, sensor data, push notifications, location data, etc. Base station 102 may transmit a paging notification 302 to user equipment 101 to inform about available downlink data, the paging notification comprising at least an identifier associated to the user equipment 101, for example a I-RNTI.

In some embodiments, the paging notification 302 may comprise an indication that downlink small data is available for transmission, and a priority flag associated with said downlink small data. In some examples, said priority flag may be a one-bit PagingDLdataInformation field included in the PagingUE-Identity data structure defined by 3GPP TS38.331 specification.

The priority flag may be a one-bit binary flag set by base station 102 when the received data is of high priority. A high priority flag may be set depending on several factors, like data priority, data volume threshold, traffic pattern or the like. In the example of FIG. 3a, the paging notification 302 comprises a priority flag set to “1”, indicating that high priority data is pending.

User equipment 101 receives the paging notification 302 at step 303 and decodes the priority flag set by the base station 102.

At step 304, user equipment 101 may determine at least a Synchronization Signal Reference Signal Received Power (SSB RSRP). In the example of FIG. 3a, it is considered that all SSB's RSRP are below a threshold (i.e., bad radio quality is experienced).

If user equipment 101 receives “1” in the paging notification message, meaning that high priority data is pending, it may trigger RA-SDT or CG-SDT procedure at step 305 and inform base station 102 about SSB's RSRP result is below the threshold through 2-step RACH/4-step RACH/CG. Base station 102 may be informed of SSB's RSRP being below the threshold in a paging response message 306. In some examples, a radio quality flag (e.g., a bit, or a CQI Index) may be set in message 306 to indicate SSB's RSRP determined at step 304 is below the threshold.

According to an embodiment, base station 102 may receive the paging response 306 at step 307 and, based on the received flag, it may select a lower/more robust modulation scheme to transmit data to user equipment 101. Base station 102 may send Small Data at step 308 in a message 309 using a MCS selected at step 307. This way, urgent data may be received by user equipment 101 at step 311 while limiting the risk of retransmission, signaling overhead and power consumption when poor radio conditions are experienced by user equipment 101.

According to an embodiment shown in FIG. 3b, instead of selecting a low MCS based on received quality flag at step 307 and send Small Data at step 308, base station 102 may take a skip decision at step 311 when quality flag indicates that all SSB's RSRP are below a threshold and schedule DL SDT in the next paging cycle. During step 312, base station 102 may configure a second wake up cycle using a message 313, for example msgB (2 step RACH) or msg4 (4 step RACH) or MAC CE (in case of Configured Grant (CG)) if it decides to skip downlink SDT.

User equipment may then configure at step 314 a wake up according to the second wake up cycle to receive downlink small data. This way, base station 102 may avoid sending data when no SSB RSRP has suitable quality, thus limiting the risk of retransmission and signaling overhead.

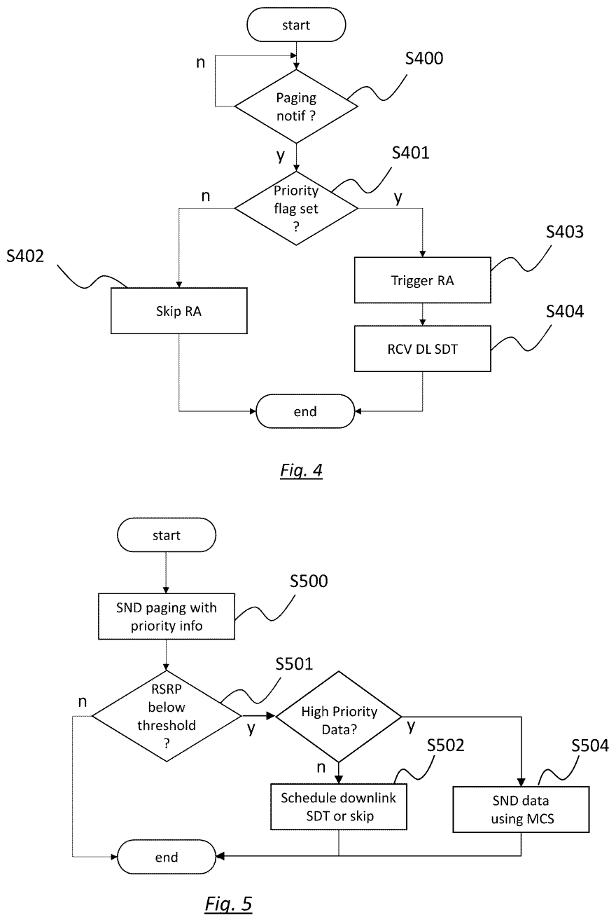

FIG. 4 is a flow chart depicting main steps of a state machine suitable for implementing a method for receiving small data transmission by a user equipment according to an embodiment.

At step S400, user equipment waits for a paging notification while in RRC inactive state. Upon reception of a paging notification indicating that Small Data is available for transmission at the serving base station, the user equipment decodes the received notification and checks whether a priority flag is included and the value of said priority flag at step S401. When priority flag is included in the received paging notification and indicates that pending small data is of low priority, then user equipment may skip random access procedure at step S402 and wait for next paging cycle.

On the other hand, when it is found at step S401 that pending data is of high priority, user equipment triggers random access procedure and indicates base station that SSB's RSRP is below a threshold at step S403 and receives downlink SDT during step S404 on a low MCS configured by base station based on said RSRP indication or, in an alternate embodiment, receive an indication of skipping downlink data until next paging cycle.

FIG. 5 is a flow chart showing main steps of a state machine suitable for implementing a method for performing small data transmission by a base station according to an embodiment.

At step S500, base station may receive some small data to send to a user equipment, which is in RRC inactive state. Base station may prepare a paging notification comprising an indication regarding the priority of the data to send as already described hereinabove and send the paging notification to user equipment.

At step S501, base station may receive a message from user equipment in response to the paging notification. Said message may comprise a flag indicating whether all SSB's RSRP are below a preconfigured threshold.

When said flag indeed indicates to the base station that all SSB's RSRP are below the threshold, base station may perform step S502 during which base station may decide to schedule the SDT in a further paging cycle, or to perform data transmission using a low MCS in step S504.

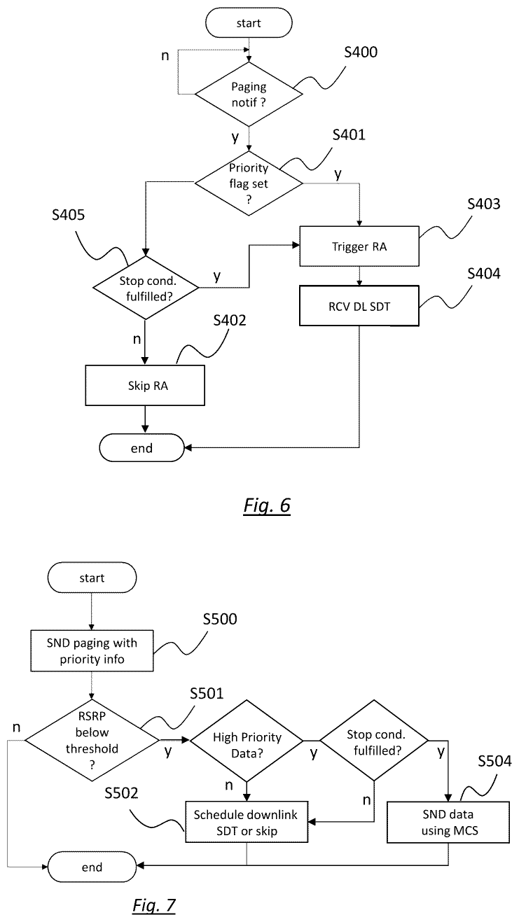

FIG. 6 shows a flow chart showing main steps of a state machine suitable for implementing a method for performing small data transmission by a base station according to a further embodiment, based on the embodiment shown in FIG. 4. The method with the steps in shown in FIG. 4 may be repeated when the reception is skipped or re-scheduled. In case that the data to be received has not been sent yet by the base station, and step S402 would be performed repeatedly, in an additional step S405 before step S402, it is checked if a stop criterion is fulfilled. Such a stop-criterion may be, for example, one of a pre-configured number of repetitions, a further flag in the paging message, a further flag in the paging response message, or a detected static or deteriorating radio condition. If the stop-criterion is fulfilled, instead of skipping the reception, the data is received according to a low modulation scheme.

FIG. 7 is a flow chart showing main steps of a state machine suitable for implementing a method for performing small data transmission by a base station according to a further embodiment, based on the embodiment shown in FIG. 5. The method with the steps in shown in FIG. 5 may be repeated when the transmission is skipped or re-scheduled. In case that the data to be transmitted has not been sent yet by the base station, and step S502 would be performed again, before performing step S502 again, it is checked if a stop criterion is fulfilled. Such a stop-criterion may be, for example, one of a pre-configured number of repetitions, a further flag in the paging message, a further flag in the paging response message, or a detected static or deteriorating radio condition. If the stop-criterion is fulfilled, instead of skipping the reception, the data is transmitted according to a low modulation scheme in step S504.

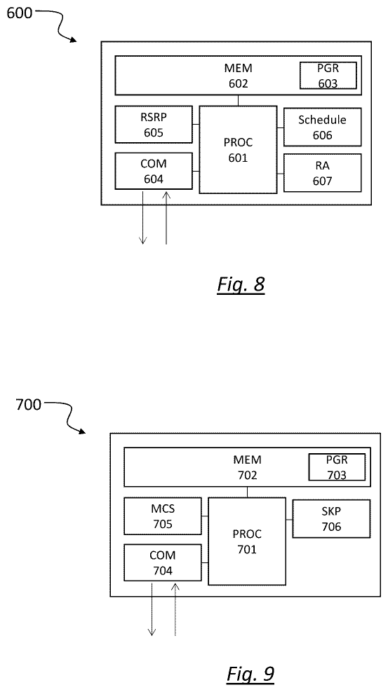

FIG. 8 is a block diagram showing a schematic architecture of an apparatus 600 suitable to implement a method of wireless communication for receiving a Small Data Transmission (SDT) from a base station, according to an embodiment.

The apparatus 600 comprises a processor 601 and a memory 602, for example a Random Access Memory (RAM). The processor 601 may be controlled by a computer program 603 stored in the memory 602 comprising instructions configured to implement a method for receiving Small Data Transmission (SDT) from a base station in a wireless communication network.

More precisely, the computer program 603 comprises instructions for receiving a paging notification from a base station while in inactive state, the paging notification comprising at least an indication that downlink small data is available for transmission, and a priority flag associated with said downlink small data, to determine at least a Synchronization Signal Reference Signal Received Power, and to postpone downlink data reception until next paging cycle when said priority flag indicates low priority downlink data and said at least a Synchronization Signal Reference Signal Received Power is below a threshold.

On initialization, instructions of the computer program 603 may be loaded into the memory 602 before being executed by the processor 601. The processor 601 implements the steps of the method according to the instructions of the computer program 603.

The apparatus 600 comprises a wireless communication unit 604, for example, a 3G, 4G, 5G, 5G NR, WiFi or WiMax transceiver for exchanging messages with other apparatus. In particular, communication unit 604 is configured by program instructions to receive a paging notification broadcasted by a base station and check if the received paging is addressed to the apparatus by comparing an identifier comprised in said paging notification with an identifier associated with the apparatus. The communication unit 605 may be further configured to obtain an indication from said paging notification, regarding a priority associated with available small data. This indication may be a binary flag included in a PagingUE-Identity data field of the paging notification wherein the flag is set to indicate high priority small data.

The apparatus 600 further comprises a channel quality sensor 605. The channel quality sensor may be configured by computer program instructions to measure the signal strength on one or more available SSBs (Synchronization Signal Blocks), and to compare the measured values to a preconfigured threshold to determine whether all SSB's RSRP are below said threshold value.

According to an embodiment, the apparatus 600 further comprises a scheduler unit 606. The scheduler unit 606 may be configured by computer program instructions to postpone downlink data reception until next paging cycle when said priority flag received by communication unit 604 indicates low priority downlink data and when the channel quality sensor 605 determines that said measured all SSB's RSRP are below said threshold.

In some embodiments, the apparatus 600 may comprise a random access module 607 configured by computer program instructions to initiate a Random Access Procedure. The Random Access Procedure may include the sending through the communication unit 604 of a quality indicator determined by the channel quality sensor 605 to the serving base station. In some examples, the quality indicator is sent as a binary flag, which is set to indicate that all SSB's RSRP are below a preconfigured threshold.

According to an embodiment, the communication unit 604 is further configured by computer program instructions to receive downlink data from the base station, said downlink data being transmitted using a low modulation scheme selected by said base station based on said at least a Synchronization Signal Reference Signal Received Power is below a threshold.

In some embodiments, the apparatus 600 is included in a user equipment device, like a smartphone, a laptop, an IoT (Internet of Things) device or a vehicle.

FIG. 9 is a block diagram showing a schematic architecture of an apparatus 700 suitable to implement a method of wireless communication for performing a Small Data Transmission (SDT) to a user equipment, according to an embodiment.

The apparatus 700 comprises a processor 701 and a memory 702, for example a Random Access Memory (RAM). The processor 701 may be controlled by a computer program 703 stored in the memory 702 comprising instructions configured to implement a method for receiving Small Data Transmission (SDT) from a base station in a wireless communication network.

More precisely, the computer program 703 comprises instructions configured to transmit a paging notification to a user equipment in inactive state, the paging notification comprising at least an indication that downlink small data is available for transmission, and a priority flag associated with said downlink small data, to receive a paging response comprising at least an indication that at least a Synchronization Signal Reference Signal Received Power is below a threshold, and to transmit downlink data using a modulation scheme selected based on said Synchronization Signal Reference Signal Received Power indication received.

On initialization, instructions of the computer program 703 may be loaded into the memory 702 before being executed by the processor 701. The processor 701 implements the steps of the method according to the instructions of the computer program 703.

The apparatus 700 comprises a wireless communication unit 704, for example, a 3G, 4G, 5G, 5G NR, WiFi or WiMax transceiver for exchanging messages with other apparatus. In particular, communication unit 704 is configured by program instructions to transmit a paging notification to a user equipment in inactive state, when small data is available for download, the paging notification comprising at least an indication that downlink small data is available for transmission, and a priority flag associated with said downlink small data. According to an embodiment, said indication may be a binary flag included in a PagingUE-Identity data field of the paging notification wherein the flag is set to indicates high priority small data.

The wireless communication unit 704 may be further configured by computer program instructions to receive a response to said paging notification from a user equipment and for obtaining, from said response received, a quality indicator representative of whether all SSB's RSRP measured by said user equipment are below a preconfigured threshold value.

In some embodiments, the apparatus 700 further comprise a modulation scheme selector module 705. The MCS selector module may be configured by computer program instructions to select a low MCS when the quality indicator representative received by the communication unit 704 indicates that all SSB's RSRP determined by the user equipment are below a preconfigured threshold value.

The communication unit 704 may be further configured by computer program instructions to transmit downlink data using a MCS selected by the MCS selector module 705; i.e., to transmit small data using a low MCS when all SSB's RSRP measured by user equipment are below the threshold.

According to an embodiment, the apparatus 700 may comprise a skip module 706 configured to skip small data transmission and schedule it in a next paging cycle when the received quality indicator indicates that all SSB's RSRP are below the threshold.

In some embodiment, the apparatus 700 is included in a base station, like a gNodeB or an eNodeB.

### LIST OF REFERENCE NUMERALS

101 user equipment
102 base station
200 user equipment switches to RRC inactive state
201 base station receives downlink small data destined for user equipment
202 paging notification message, go to sleep mode
203 user equipment receives paging notification
204 user equipment measures signal quality and determines SSB RSRP
205 small data reception is skipped/postponed
300 user equipment switches to RRC inactive state
301 base station receives downlink small data destined for user equipment
302 paging notification message
303 user equipment receives paging notification
304 user equipment determines SSB RSRP
305 user equipment triggers RA-SDT or CG-SDT procedure
306 paging response message
307 base station receives paging response
308 base station sends Small Data
309 small data message
311 user equipment receives Small Data
S400-S404 method steps
S500-S505 method step
600 apparatus
601 processor
602 memory
603 computer program
604 communication unit
605 channel quality sensor
606 scheduler unit
607 random access module
700 apparatus
701 processor
702 memory
703 computer program
704 wireless communication unit
705 MCS selector module
706 skip module

1. A method for receiving Small Data Transmission by a user equipment device connected to a wireless communication network, wherein the method comprises:
receiving a paging notification from a base station while in inactive state, the paging notification comprising at least:
an indication that downlink small data is available for transmission, and
a priority flag associated with said downlink small data,
determining at least one Synchronization Signal Reference Signal Received Power,
postponing downlink data reception until next paging cycle when said priority flag indicates low priority downlink data and all of the at least one Synchronization Signal Reference Signal Received Powers are below a threshold.

2. The method according to claim 1 wherein the method comprises, when said priority flag indicates high priority downlink data and said at least a Synchronization Signal Reference Signal Received Powers are below a threshold:
sending a paging response comprising at least a flag indicating that all of said at least one Synchronization Signal Reference Signal Received Powers are below a threshold, and
receiving downlink data from the base station, said downlink data being transmitted using a low modulation scheme selected by said base station when based on said indication that all of the at least one Synchronization Signal Reference Signal Received Powers are below a threshold.

3. The method according to claim 2, wherein the step of sending a paging response comprising at least a flag indicating that all of said at least one Synchronization Signal Reference Signal Received Powers are below a threshold is performed by the user equipment through 2-step Random Access Channel, RACH, 4-step RACH or, preConfigured Grant, CG.

4. The method according to claim 1 wherein the method comprises, when said priority flag indicates high priority downlink data and said at least a Synchronization Signal Reference Signal Received Power is below a threshold:
sending a paging response comprising at least a flag indicating that said all of the at least one Synchronization Signal Reference Signal Received Powers are below a threshold, and
receiving an instruction for skipping downlink data until next paging cycle.

5. The method according to claim 3, wherein the steps sending a paging response comprising at least a flag indicating that all of the said at least one Synchronization Signal Reference Signal Received Powers are below a threshold, and receiving an instruction for skipping downlink data until next paging cycle are performed repeatedly; and if a stop-criterion occurs, the step receiving downlink data from the base station, said downlink data being transmitted using a low modulation scheme selected by the said base station, is performed.

6. The method according to claim 5, wherein the stop-criterion is one of
a pre-configured number of repetitions;
a further flag in the paging message;
a further flag in the paging response message; or
a detected static or deteriorating radio condition.

7. The method according to claim 5, wherein a pre-configured number of repetitions is configured in the base station and/or the user equipment device.

8. An apparatus for receiving Small Data Transmission from a base station in a wireless communication network, the apparatus comprising a wireless transceiver, a processor coupled with a memory in which computer program instructions are stored, said instructions being configured to implement:
receiving a paging notification from a base station while in inactive state, the paging notification comprising at least:
an indication that downlink data is available for transmission, and
a priority flag associated with said downlink data,
determining at least a Synchronization Signal Reference Signal Received Power,
postponing downlink data reception until at least next the paging cycle when said priority flag indicates low priority downlink data and said at least a Synchronization Signal Reference Signal Received Power is below a threshold.

9. The apparatus according to claim 8, wherein the apparatus 600 further comprises a scheduler unit configured to postpone downlink data reception until the at least next paging cycle when said priority flag received by communication unit indicates low priority downlink data, and when the channel quality sensor determines that said measured all SSB's RSRP are below said threshold.

10. The apparatus according to claim 8, wherein the apparatus is a user equipment.

11. A method for performing Small Data Transmission by a base station in a wireless communication network, wherein the method comprises:
transmitting a paging notification to a user equipment in inactive state, the paging notification comprising at least:
an indication that downlink small data is available for transmission, and
a priority flag associated with said downlink small data,
receiving a paging response comprising at least an indication that all of at least one Synchronization Signal Reference Signal Received Powers are below a threshold, and
transmitting downlink data using a modulation scheme selected based on said Synchronization Signal Reference Signal Received Power indication received.

12. The method according to claim 11, wherein step said transmitting downlink data using a modulation scheme selected based on said Synchronization Signal Reference Signal Received Power indication received is preceded by receiving a paging response comprising at least a flag indicating that all of the at least one Synchronization Signal Reference Signal Received Powers are below a threshold, and transmitting an instruction for skipping downlink data until next paging cycle.

13. An apparatus for performing Small Data Transmission in a wireless communication network, the apparatus comprising a wireless transceiver and a processor coupled with a memory in which computer program instructions are stored, said instructions being configured to implement:
transmitting a paging notification to a user equipment in inactive state, the paging notification comprising at least:
an indication that downlink small data is available for transmission, and
a priority flag associated with said downlink small data,
receiving a paging response comprising at least an indication that all of at least a synchronization Signal Reference Signal Received Powers are below a threshold, and
transmitting downlink data using a modulation scheme selected based on said Synchronization Signal Reference Signal Received Power indication received.

14. The apparatus according to claim 13, wherein the apparatus is a base station.

15. A wireless communication system, for performing small data transmission from a base station to a user equipment, comprising the base station and the user equipment, wherein the base station comprises a base-station processor coupled with a base-station memory in which base-station computer program instructions are stored, said base-station computer program instructions being configured to implement:
transmitting a paging notification to a user equipment in inactive state, the paging notification comprising at least:
an indication that downlink small data is available for transmission, and
a priority flag associated with said downlink small data,
wherein the user equipment comprises a user-equipment processor coupled with a user-equipment memory in which user-equipment computer program instructions are stored, said user-equipment computer program instructions being configured to implement:
receiving said paging notification from a base station while in inactive state, the paging notification comprising at least:
an indication that downlink data is available for transmission, and
a priority flag associated with said downlink data,
determining at least one Synchronization Signal Reference Signal Received Power,
postponing downlink data reception until at least next paging cycle when said priority flag indicates low priority downlink data and all of said at least one Synchronization Signal Reference Signal Received Powers are below a threshold.

16. The apparatus according to claim 9, wherein the apparatus is a user equipment.
